(19) United States
(12) Patent Application Publication
(10) Pub. No.: US 2008/0052388 A1
(43) Pub. Date: Feb. 28, 2008

(54) Substitutable domain management system and method for substituting the system

(75) Inventors: Tymur Korkishko, Yongin-si (KR); Kyung-Hee Lee, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/822,095

(22) Filed: Jul. 2, 2007

(30) Foreign Application Priority Data
Aug. 28, 2006 (KR) 10-2006-0081566

(51) Int. Cl. G06F 15/173

(52) U.S. Cl. 709/223

(57) ABSTRACT

A domain management method and substitutable system is provided. When a domain manager, which manages digital rights in a local area, permanently or temporarily becomes unavailable, the domain management method and system may protect the digital rights of the area by using another domain manager.

### CROSS-REFERENCE TO RELATED APPLICATION

This application claims the benefit under 35 U.S.C. § 119(a) of a Korean Patent Application No. 10-2006-0081566, filed on Aug. 28, 2006 in the Korean Intellectual Property Office, the entire disclosure of which is hereby incorporated by reference.

### BACKGROUND OF THE INVENTION

1. Field of the Invention

The present invention relates to a domain management system for the protection of digital contents based on a domain. More particularly, the present invention relates to a substitutable domain management system depending upon circumstances, and a method of operating the system.

2. Description of Related Art

Digital content protection is a very important issue for content owners. If there is no content protection mechanism, content owners cannot receive a profit from a distributed content since anyone can freely access and utilize the distributed content. Accordingly, content owners usually implement some mechanism that allows them to protect the content from unauthorized access and consumption. Typically, Digital Rights Management (DRM) is involved for protection of digital contents.

One method of DRM protection allows a group of devices to share content. In this instance, the group of devices is referred to as a single domain and the devices belonging to the single domain are allowed to share content. Such devices may, for example, have the same account information on a content provider server and share access to digital content. A user may access the content that is allowed for the domain using any of the devices.

However, to manage digital content based on a domain, as described above, each of the group of devices should be registered with a content provider or a digital rights issuer. In this case, the device should have the ability to access the Internet and a great amount of time is required when the device is registered as a member of the domain. Also, when creating the domain, all the member devices of the domain should be registered. Accordingly, a local domain management apparatus which can allow a domain membership even for devices that have no network access ability, and that provides user convenience of domain management, is provided.

FIG. 1 is a block diagram illustrating a network configuration of a local domain management device 110 according to a related art.

As shown in FIG. 1, the local domain management device 110 may communicate with a plurality of devices 120, 130 and 140 via a limited distance communication channel interface. Also, the local domain management device 110 is connected to a rights issuing server 150 via a network, and thereby can manage digital contents with respect to a domain which includes the plurality of devices 120, 130 and 140. Accordingly, although each of the devices 120, 130 and 140 is not directly connected to the rights issuing server 150, each of the devices 120, 130 and 140 may be delegated with rights regarding digital content by using the local domain management device 110.

However, according to the related art, when the local domain management device 110 becomes unavailable due to loss, damage and the like, the domain may not be managed. The only alternative is to create a new domain by using a new local domain management device. However, in this case, the new local domain management device may not detect existing domain management information that includes rights about already purchased digital content. Accordingly, any existing domain management information is required to be abandoned.

Accordingly, a need exists for a domain management method and system which enables a user to easily manage a domain by utilizing existing domain management information via another local domain management device even when a corresponding local domain management device is permanently or temporarily unavailable.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a substitutable domain management system.

An aspect of exemplary embodiments of the present invention also provides a domain management method and system which can manage a domain by using existing domain management information even after a corresponding domain manager is substituted.

An aspect of exemplary embodiments of the present invention also provides a domain management method and system which can maintain an association between a member device of a domain and a new domain after substituting a domain manager, and thereby can conveniently substitute the domain manager.

According to an aspect of exemplary embodiments of the present invention, a domain manager for managing a user domain includes an assignment request unit for requesting a domain authority (DA) to assign the domain manager to the user domain, a user domain management state (UDMS) information receiving unit for receiving UDMS information about the user domain from the DA when the domain manager is assigned to the DA, and a user domain management unit for managing the user domain based on the received UDMS information.

In an exemplary implementation, the UDMS information corresponds to information which is stored in the DA by another domain manager and the other domain manager corresponds to a system that manages the user domain before the domain manager is registered to the DA. Also, the other domain manager may be permanently unavailable due to loss, damage and the like, and may be temporarily unavailable to utilize the domain manager.

According to another aspect of exemplary embodiments of the present invention, a domain management method includes requesting a DA to assign a domain manager to a user domain, receiving UDMS information about the user domain from the DA when the domain manager is assigned to the DA, and managing the user domain based on the received UDMS information.

According to another aspect of exemplary embodiments of the present invention, a domain management method includes assigning a first domain manager to a user domain of a user, storing UDMS information about the user domain in a DA, assigning a second domain manager to the user domain, receiving the UDMS information from the DA by the second domain manager, and managing the user domain by the second domain manager based on the UDMS information.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following detailed description, taken in conjunction with the accompanying drawings in which:

FIG. 1 is a block diagram illustrating a network configuration of a local domain management device according to a related art;

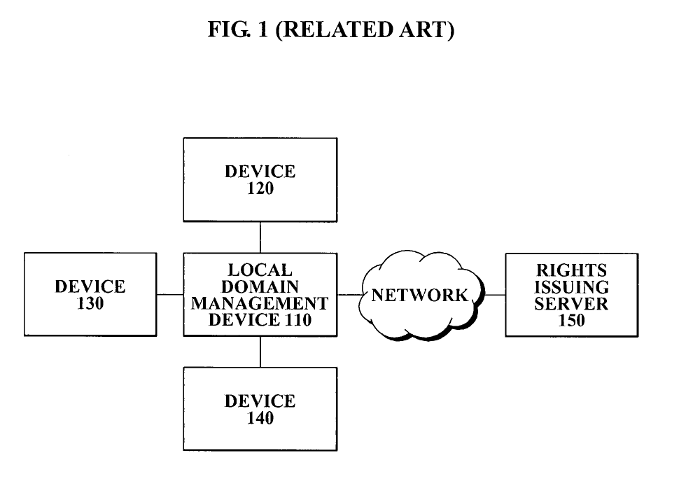

FIG. 2 is a block diagram illustrating an internal configuration of a domain manager according to an exemplary embodiment of the present invention;

FIG. 3 is a flowchart illustrating a method of registering a domain manager to a domain authority (DA) according to an exemplary embodiment of the present invention;

FIG. 4 is a flowchart illustrating a method of performing user domain management according to an exemplary embodiment of the present invention;

FIG. 5 is a flowchart illustrating a method of storing user domain management state (UDMS) information of a domain manager in a DA according to an exemplary embodiment of the present invention; and

FIG. 6 is a flowchart illustrating a method of applying a substitution of a domain manager in a device according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

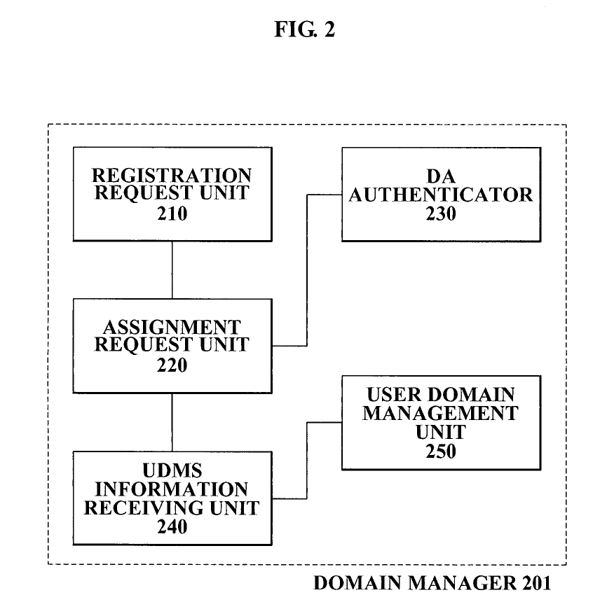

FIG. 2 is a block diagram illustrating an internal configuration of a domain manager 201 according to an exemplary embodiment of the present invention.

The domain manager 201 may be installed in a device that includes a limited distance communication channel interface for communicating with other devices among devices for using digital contents, and a network interface for a communication with a domain authority (DA) via a network. For example, the domain manager 201 may be included in a personal digital assistant (PDA), a mobile terminal, a computer terminal, and the like. Also, the domain manager 201 may be constructed as a separate device for managing a user domain, while not being included in other devices, as described above.

As shown in FIG. 2, the domain manager 201 includes a registration request unit 210, an assignment request unit 220, a DA authenticator 230, a user domain management state (UDMS) information receiving unit 240, and a user domain management unit 250. The above-described elements may be configured as software, hardware, or a combination of software and hardware. In this instance, the elements may be connected to each other. Hereinafter, each of the elements will be described in detail.

The registration request unit 210 requests a DA to register the domain manager to the DA. In an exemplary implementation, the DA stores information about a user domain, information about a state of the user domain, or information about the domain manager 201 which manages the user domain. Also, the DA functions to provide the stored information to a domain management device. The DA may utilize a database to store the information. In an exemplary implementation, the database may include a common database management system (DBMS) and may include various types of software and hardware that may store and manage data.

The registration request unit 210 may transmit a user credential to the DA to request registration of the domain manager 201. In an exemplary implementation, the user credential may include a user's user identifier and password. The DA may authenticate the user by using the user credential. The DA may prevent access of an unknown user through a user authentication process, and may also identify the user's user domain.

Also, the registration request unit 210 may transmit information about the domain manager 201 to the DA to request the registration of the domain manager 201. The information about the domain manager 201 may include a domain manager identifier for identifying the domain manager 201, and a domain manager public key for verifying a signed signature in the domain manager 201.

The assignment request unit 220 requests the DA to assign the domain manager 201 to the user domain. In an exemplary implementation, the domain manager 201 should be registered to the DA so that the assignment request unit 220 may request the DA to assign the domain manager 201. Accordingly, when the domain manager 201 is registered to the DA and thus, the DA authenticator 230 authenticates the DA, the assignment request unit 220 requests the DA to assign the domain manager 201 to the user domain.

The DA authenticator 230 authenticates the DA by using a DA credential that is received from the DA. In response to the registration request from the registration request unit 210, the DA registers the domain manager 210 to the DA. When the registration is completed, the DA credential may be transmitted to the DA authenticator 230 to verify the DA. In an exemplary implementation, the DA credential corresponds to information for authenticating the DA and thus, may include a DA public key certificate, a DA identifier, a DA name, a DA description, and the like.

The DA authenticator 230 may authenticate a DA when registering the domain manager 201 to the DA, as described above. Also, the DA authenticator 230 may authenticate a DA when transmitting information to the DA, or receiving information from the DA, such as storing UDMS information in the DA.

The UDMS information receiving unit 240 receives UDMS information about the user domain from the DA. When the domain manager 201 is registered to the DA and assigned to the user domain, the UDMS information is transmitted from the DA. In an exemplary implementation, the UDMS information includes a number of devices that are registered to a member of the user domain, a device identifier of each registered device, a device public key certificate of each registered device, a user domain identifier, a user domain credential, a user domain expiration time, a domain policy, and the like. Also, the UDMS information may include any type of information for user domain management as required.

Accordingly, when the received UDMS information is utilized, the domain manager 201 may identify devices that are included as a member of the user domain, authenticate each of the devices, and also detect various types of information about the user domain. Also, the domain manager 201 may be delegated with rights of desired digital contents from a rights issuing server, which issues rights of digital contents, by using the user domain credential.

The UDMS information received by the UDMS information receiving unit 240 is stored in the DA. In this instance, the DA may store and manage the UDMS information in a database. Also, the UDMS information may correspond to information which is utilized by another domain manager, not the domain manager 201, to manage a user domain and is stored in the DA. Accordingly, even when the other domain manager managed the user domain but may be permanently or temporarily unavailable, the domain manager 201 may similarly manage the user domain by receiving the UDMS information for user domain management. Consequently, since another user domain is not required to be created, a domain manager may be easily substituted.

For example, when a domain manager in use becomes unavailable due to a loss or damage, a user domain may be managed in the same way as in an existing domain manager, by registering a new domain manager to a DA and receiving UDMS information. Also, even when the domain manager in use normally operates but there is a temporary inability or inconvenience to utilize the domain manager, for example, since a user forgot the domain manager at their home, a user domain may be managed in the same way, by using a new domain manager.

The user domain management unit 250 manages the user domain based on the UDMS information that is received by the UDMS information receiving unit 240. As described above, since the UDMS information includes various types of information to manage the user domain, the user domain may be managed by using the UDMS information.

The user domain management unit 250 manages a user domain for communicable devices via a limited distance communication channel interface. In this instance, the user domain management unit 250 manages the user domain by allowing each of the devices to join or leave the user domain. To manage the user domain as described above, the user domain management unit 250 receives a user domain management request from the communicable device via the limited distance communication channel interface, and manages the user domain in response to the user domain management request.

The user domain management request may include a join request or a leave request with respect to the user domain of the device. Also, the user domain management unit 250 allows the device to join or leave the user domain in response to the join request or the leave request that is included in the user domain management request. In an exemplary implementation, the user domain management request may be received with an electronic signature that is signed with a private key of the device with respect to the user domain management request.

In this instance, the user domain management unit 250 authenticates a device that has transmitted the user domain management request. The user domain management request may include authentication information to authenticate the device. The user domain management unit 250 authenticates the device based on the authentication information. When the device is authenticated, the user domain management unit 250 creates a domain manager status request based on the user domain management request, and transmits the created domain manager status request to the DA. In an exemplary implementation, the domain manager status request may include the user domain management request, and may be transmitted with an electronic signature that is signed with a private key of the domain manager with respect to the domain manager status request. Accordingly, the DA may determine whether the domain manager status request has been created by a valid domain manager assigned to the user domain, based on the electronic signature.

Also, the user domain management unit 250 receives a domain manager status response with respect to the domain manager status request from the DA, and updates the UDMS information based on the domain manager status response. Specifically, the DA receives the domain manager status request and determines whether the status of the user domain is normally changed. When the status of the user domain is normally changed, the DA transmits the domain manager status response to the user domain management unit 250. Accordingly, the user domain management unit 250 receives the domain manager status response and performs a domain management action corresponding to the user domain management request. When the domain management action is performed as described above, the status of the user domain is changed and thus, the user domain management unit 250 updates the UDMS information.

Also, the user domain management unit 250 may transmit the updated UDMS information to the DA. The DA receives the updated UDMS information, and updates UDMS information that is stored in the DA. Specifically, when the status of the user domain is changed, the change is immediately reflected in UDMS information that is stored in the DA. Accordingly, the DA may maintain the most recent UDMS information. Also, even when a sudden substitution of the domain manager is required, the user domain may be managed in the same way, by using a new domain manager.

Also, the user domain management unit 250 creates a user domain management response based on the domain manager status response, and transmits the created user domain management response to a device that has transmitted a user domain management request. In an exemplary implementation, the user domain management response includes the domain manager status response, and may be transmitted with an electronic signature that is signed with a private key of the domain manager with respect to the user domain management response. Accordingly, the device may determine whether the user domain management response is received from a valid domain manager based on the electronic signature.

To verify the electronic signature, the device should have a public key of the domain manager 201. When a domain manager is assigned to a user domain, the user domain management unit 250 transmits a request for changing a domain manager to all connectable devices via a limited distance communication channel interface, so that each device may change a corresponding domain manager and receive information of the domain manager 201 assigned to the user domain.

When the device includes a network interface, the device may be directly connected to a DA, not using the user domain management unit 250 of the domain manager 201, and thereby perform domain management. In this case, UDMS information of the DA is updated in association with any change in the user domain, and the domain manager receives and updates the UDMS information.

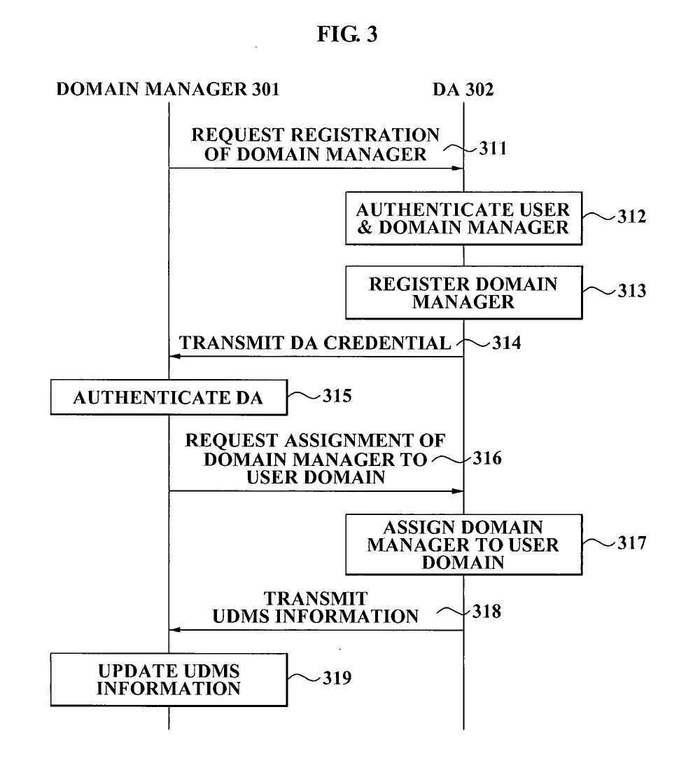

FIG. 3 is a flowchart illustrating a method of registering a domain manager 301 to a DA 302 according to an exemplary embodiment of the present invention.

To manage a user domain by using the domain manager 301, the domain manager 301 should be registered to the DA 302 and also assigned to the user domain. Accordingly, to register the domain manager 301 to the DA 302, the domain manager 301 transmits a domain manager registration request to the DA 302 in step 311. According to an exemplary embodiment, the domain manager registration request may include a user credential. The user credential may include a user identifier and a password. For example, the DA 302 may determine whether the domain manager 301 is a valid system by authenticating a user using the user credential. In this instance, the user credential may be not included in the domain manager registration request, but transmitted to the DA 302 via another process. In this case, a reliable relation between the user and the DA 302 should be maintained until the domain manager registration request is received by the DA 302.

In step 312, when the domain manager registration request is received, the DA 302 authenticates the user and the domain manager 301. As described above, the user may be authenticated by using the user credential. When the user credential is not included in the domain manager registration request, but received via another process, the user authentication may be completed before receiving the domain manager registration request. Also, the domain management registration request should include authentication information of the domain manager 301 to authenticate the domain manager 301. Depending upon an exemplary implementation, the authentication information may include a domain manager identifier, a domain manager public key certificate, a domain manager public key/private key pair, and the like. Also, the authentication information may include various types of information which is required to authenticate the domain manager 301.

In step 313, when the user and the domain manager 301 are authenticated, the DA 302 registers the domain manager 301. When the domain manager 301 is registered, the DA 302 stores information about the domain manager 301 in a recording medium, such as a database and the like. Also, the DA 302 may process a request from the domain manager 301 and manage the domain manager 301 by using the information.

In step 314, when the domain manager 301 is registered to the DA 302, the domain manager 302 transmits a DA credential to the domain manager 301. Depending upon an exemplary implementation, the DA credential may include a DA public key certificate, a DA identifier, a DA name, a DA description, and the like, as information about the DA 302.

In step 315, the domain manager 301 authenticates the DA 302 by using the received DA credential. To be assigned to the user domain and receive UDMS information, whether the DA 302 is a valid server should be determined. In step 316, when authentication of the DA 302 is completed, the domain manager 301 requests the DA 302 to assign the domain manager 301 to the user domain.

In step 317, in response to the assignment request, the DA 302 may determine whether the domain manager 301 can be assigned to the user domain, and when possible, assigns the domain manager 301 to the user domain. In this instance, user authentication information using the user credential may be utilized to determine whether the domain manager 301 may be assigned to the user domain. Specifically, a user is associated with a user domain. Thus, when the user is authenticated, it can be verified that the domain manager 301 has been assigned to the user domain.

In step 318, when the domain manager 301 is assigned to the user domain, the DA 302 transmits UDMS information about the user domain to the domain manager 301. Depending upon an exemplary implementation, the UDMS information may include information that is required to manage the user domain. In step 319, the domain manager 301 updates the UDMS information to the received UDMS information. In this instance, the UDMS information may correspond to information that is stored in the DA 302 by an existing domain manager which managed the user domain. In this case, the existing UDMS may be utilized as is.

As described above, the domain manager 301 may receive UDMS information about a user domain through a registration process of the domain manager 301 to the DA 3012 and an assignment process to the user domain. The domain manager 301 may utilize the existing UDMS as is, based on the received UDMS information. The above-described descriptions may be an example of when an existing domain manager managing user domain leaves. When the user domain does not exist, a new user domain is created in step 317, without assigning the domain manager 301 to the user domain. The new user domain may be managed by transmitting newly generated UDMS information to the domain manager 301.

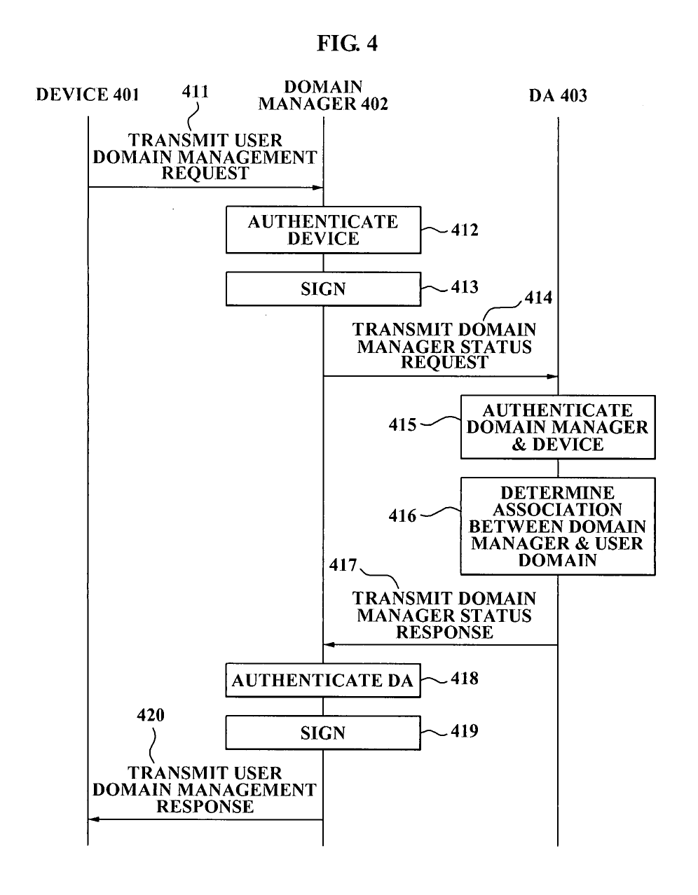

FIG. 4 is a flowchart illustrating a method of performing user domain management according to an exemplary embodiment of the present invention.

Many devices include a limited distance communication channel interface without a network interface. Accordingly, in many cases, a device 401 is connected to a domain manager 402 and thereby managed. As shown in FIG. 4, a process when the device 401 desires to join or leave a user domain is described.

In step 411, the device 401 transmits a user domain management request to the domain manager 402. Depending upon an exemplary implementation, the user domain management request may include a join request or a leave request, and authentication information to authenticate the device 401. Also, the authentication information may include a device identifier and a device public key certificate. Also, the user domain management request may be transmitted with an electronic signature that is signed with a private key of the device 401 with respect to the user domain management request.

In step 412, when the user domain management request is received, the domain manager 402 authenticates the device 401 that transmitted the user domain management request. In this instance, a validity of the user domain management request may be confirmed by verifying the electronic signature, which is received with the user domain management request, using a public key of the device 401. When authentication of the device 401 is completed, whether the device 401 belongs to a member of the user domain may be determined. When the device 401 belongs to the member of the user domain, only the leave request may be processed. When the device 401 does not belong to the member of the user domain, only the join request may be processed.

In steps 413 and 414, when the authentication is completed, the domain manager 402 creates a domain manager status request that includes the user domain management request, and transmits the created domain manager status request with an electronic signature that is signed with a private key of the domain manager 402 with respect to the domain manager status request. Since the domain manager status request includes the user domain management request, the join request or the leave request with respect to the user domain of the device 401 is also included.

In step 415, after a DA 403 receives the domain manager status request in step 414, the device 401 and the domain manager 402 are authenticated. During the authentication process, the DA 403 may determine whether the domain manager status request created by the domain manager 402 is a valid request by verifying the electronic signature about the domain manager status request with the public key of the domain manager 402. Also, the DA 403 may determine whether the user domain management request, included in the domain manager status request, is valid by verifying the electronic signature about the user domain management request with the public key of the device 401.

In step 416, when the authentication of the DA 403 is completed, whether the domain manager 402 is assigned to the user domain is determined. The determination may be performed based on information about the domain manager 402, which is stored in the DA 403 when the domain manager 402 is registered to the DA 403 and assigned to the user domain.

In step 417, when the determination is completed, the DA 403 transmits a domain manager status response to the domain manager 402 in response to the domain manager status request. The domain manager status response may be transmitted with an electronic signature that is signed with a private key of the DA 403 with respect to the domain manager status response. In step 418, when the domain manager status response is received, the domain manager 402 authenticates the DA 403. In this instance, the electronic signature may be verified by using a public key of the DA 403. In step 419, when the authentication of the DA 403 is completed, the domain manager 402 creates a user domain management response that includes the domain manager status response, and signs the user domain management response with the private key of the domain manager 402. In step 420, the domain manager 402 transmits the user domain management response and the signed signature to the device 401.

The device 401 may determine whether the device 401 is allowed to join or leave the user domain by receiving the user domain management response. Also, when the domain manager status response is received in step 417, the status of the user domain is changed and thus, the domain manager 402 updates UDMS information and transmits the updated UDMS information to the DA 403, so that the DA 403 may maintain the most recent UDMS information. Accordingly, even when the domain manager 402 is substituted with another domain manager, the user domain may be managed in the same way, by using the latest UDMS that is stored in the DA 403.

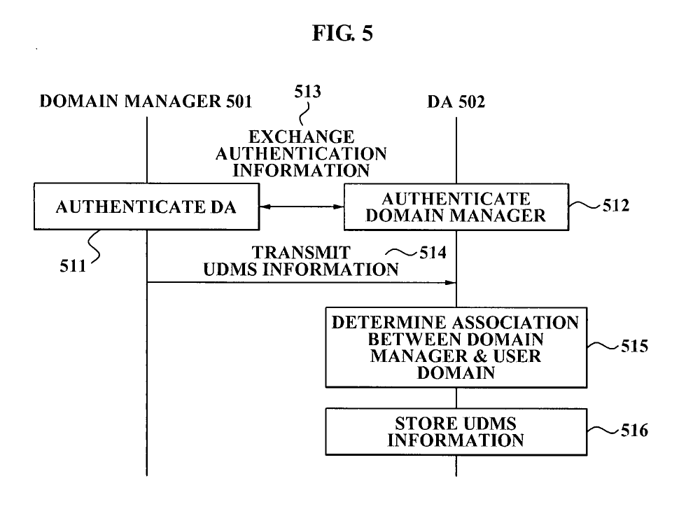

FIG. 5 is a flowchart illustrating a method of storing UDMS information of a domain manager in a DA according to an exemplary embodiment of the present invention.

When a user domain is managed by a domain manager 501 but the status of the user domain is changed, UDMS information is also changed. In this case, even when the domain manager 501 is suddenly substituted with another domain manager, the latest UDMS information may be utilized in the substituted domain manager by immediately transmitting the changed UDMS information to a DA 502. FIG. 5 illustrates a process of transmitting the UDMS information from the domain manager 501 to the DA 502.

In steps 511 through 513, the domain manager 501 and the DA 502 exchange authentication information and authenticate each other. Exchange of the authentication information may not be simultaneously performed. Specifically, in many cases, the authentication information may be exchanged by transmitting a request for transmitting UDMS information from the domain manager 501, which desires to transmit the UDMS information, to the DA 502.

In step 514, when authentication procedures are completed, the domain manager 501 transmits UDMS information to the DA 502. Depending upon an exemplary implementation, the UDMS information may include all UDMS information that is included in the domain manager 501. Also, the UDMS information may include only updated UDMS information among UDMS information that is included in the domain manager 501. Also, to update the DA 502 with the status of the domain manager 501 using UDMS information, either method may suffice.

In step 515, after the DA 502 receives the UDMS information in step 514, whether the domain manager 501 is assigned to the user domain is determined. In step 516, when the determination is completed, the DA 502 stores the received UDMS information in a recording medium, such as a database and the like.

As described above, although the domain manager 501 is substituted with another domain manager, existing user domain status information may be utilized as is without inconvenience, such as creating a new user domain, by enabling the user manager to immediately store UDMS information, thereby reflecting a change in the status of the user domain in the domain manager 501.

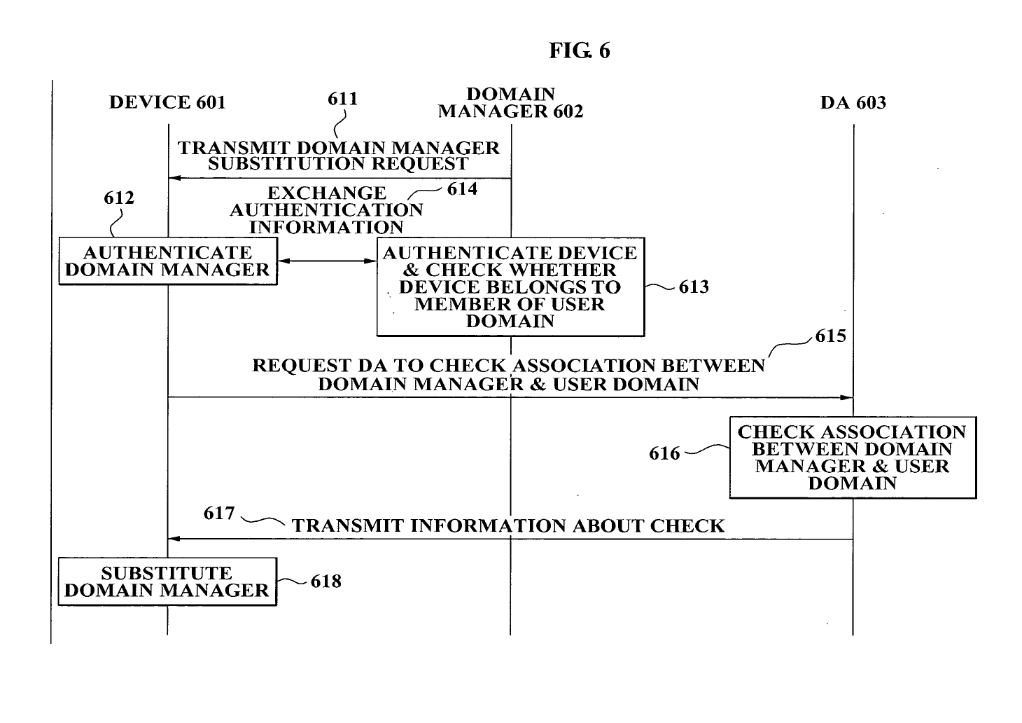

FIG. 6 is a flowchart illustrating a method of applying a substitution of a domain manager in a device according to an exemplary embodiment of the present invention.

When a domain manager 602 is substituted with a new domain manager, a device that belongs to a user domain managed by the domain manager 602 should verify that the domain manager 602 is substituted with the new domain manager, and update information about the domain manager 602 to information about the new domain manager.

In step 611, when the domain manager 602 is additionally registered and assigned to the user domain, the domain manager 602 transmits a domain manager substitution request to a communicable device 601 via a limited distance communication channel interface. In steps 612 through 614, the device 601 that belongs to a member of the user domain among the device 601, which received the domain manager substitution request, exchanges authentication information with the domain manager 602 in response to the domain manager substitution request. Also, in step 613, the domain manager 602 determines whether the device 601 belongs to the member of the user domain.

In step 615, when the authentication is completed, the device 601 requests a DA 603 to determine an association between the domain manager 602 and the user domain. According to an exemplary implementation, the association determination is to determine whether the domain manager 602 is assigned to the user domain. When the device 601 includes a network interface, the request may be directly transmitted to the DA 603. When the device does not include the network interface, the request is transmitted to the domain manager 602 via the limited distance communication channel interface, so that the domain manager 602 may transfer the request to the DA 603. In this case, although the domain manager 602 is utilized, the validity of the request may be verified in the same way as a direct transmission, by transmitting the request with a signed electronic signature using a private key of the device 601.

In step 616, after the DA 603 receives the request in step 615, whether the domain manager 602 is assigned to the user domain is determined. The determination may be performed by using information about the domain manager 602, which is stored in the DA 603, when the domain manager 602 is registered to the DA 603 and assigned to the user domain. In step 617, when the determination is completed, the DA 603 transmits information about the determination to the device 601. In the same way as determining request information, the determined information may be directly transmitted to the device 601 when the device 601 includes a network interface. Also, when the device 601 does not include a network interface, the determined information may be transmitted to the device 601 via the domain manager 602. Even when the determined information is transmitted via the domain manager 602, the device 601 may determine the validity of the determined information using a public key of the DA 603 by transmitting the determined information with an electronic signature that is signed with a private key of the DA 603 with respect to the determined information.

In step 618, when the determined information is received, the device 601 changes information about the domain manager managing the device 601 into information about the new domain manager 602. Subsequently, the device 601 is managed in the user domain via the domain manager 602.

The domain management method according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to an exemplary embodiment of the present invention, it is possible to provide a substitutable domain management system.

Also, according to an exemplary embodiment of the present invention, a domain management method and system can manage a domain by using existing domain management information even after a corresponding domain manager is substituted.

Also, according to an exemplary embodiment of the present invention, a domain management method and system can maintain an association between a member device of a domain and a new domain after substituting a domain manager, and thereby can conveniently substitute the domain manager.

While the invention has shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A domain manager for managing a user domain, the manager comprising:
an assignment request unit for requesting a domain authority (DA) to assign the domain manager to the user domain;
a user domain management state (UDMS) information receiving unit for receiving UDMS information about the user domain from the DA when the domain manager is assigned to the DA; and
a user domain management unit for managing the user domain based on the received UDMS information.

2. The domain manager of claim 1, wherein the UDMS information corresponds to information which is stored in the DA by another domain manager.

3. The domain manager of claim 1, wherein the other domain manager corresponds to a system managing the user domain before the domain manager is registered to the DA.

4. The domain manager of claim 1, further comprising:
a registration request unit for requesting the DA to register the domain manager to the DA;
wherein the assignment request unit requests the DA to assign the domain manager to the user domain when the domain manager is registered to the DA.

5. The domain manager of claim 4, wherein the registration request unit transmits a user credential to the DA to identify a user in the DA.

6. The domain manager of claim 5, wherein the user credential comprises the user's user identifier and password.

7. The domain manager of claim 4, further comprising:
a DA authenticator for authenticating the DA by using a received DA credential from the DA,
wherein the assignment request unit requests the DA to assign the domain manager to the user domain when the DA is authenticated.

8. The domain manager of claim 7, wherein the DA authenticator receives the DA credential from the DA when the domain manager is registered to the DA.

9. The domain manager of claim 7, wherein the DA credential comprises at least one of a DA public key certificate, a DA identifier, a DA name, and a DA description.

10. The domain manager of claim 1, wherein the UDMS information receiving unit receives the UDMS information from the DA when the domain manager is assigned to the user domain.

11. The domain manager of claim 1, wherein the UDMS information comprises information related to at least one of a plurality of devices that are registered to a member of the user domain, a device identifier of each registered device, a device public key certificate of each registered device, a user domain identifier, a user domain credential, a user domain expiration time, and a domain policy.

12. The domain manager of claim 1, wherein the user domain management unit receives a user domain management request from a communication device via a limited distance communication channel interface, and manages the user domain in response to the user domain management request.

13. The domain manager of claim 12, wherein the user domain management request comprises a device nonce, a domain manager identifier, a user domain identifier, and a device identifier.

14. The domain manager of claim 12, wherein the user domain management request comprises at least one of a join request, and a leave request with respect to the user domain of the device.

15. The domain manager of claim 14, wherein the user domain management unit allows the device to join or leave the user domain in response to the join request or the leave request which is comprised in the user domain management request.

16. The domain manager of claim 12, wherein the user domain management unit authenticates the device, and when the device is authenticated, creates a domain manager status request based on the user domain management request, and transmits the created domain manager status request to the DA.

17. The domain manager of claim 16, wherein the domain manager status request comprises the user domain management request, and is transmitted with an electronic signature which is signed with a private key of the domain manager with respect to the domain manager status request.

18. The domain manager of claim 16, wherein the user domain management unit receives a domain manager status response with respect to the domain manager status request from the DA, and updates the UDMS information based on the domain manager status response.

19. The domain manager of claim 18, wherein the user domain management unit transmits the updated UDMS information to the DA.

20. The domain manager of claim 18, wherein the user domain management unit creates a user domain management response based on the domain manager status response, and transmits the created user domain management response to the device.

21. The domain manager of claim 20, wherein the user domain management response comprises the domain manager status response, and is transmitted with an electronic signature which is signed with a private key of the domain manager with respect to the user domain management response.

22. A domain management method, the method comprising:
requesting a domain authority (DA) to assign a domain manager to a user domain;
receiving user domain management state (UDMS) information about the user domain from the DA when the domain manager is assigned to the DA; and
managing the user domain based on the received UDMS information.

23. The method of claim 22, wherein the UDMS information corresponds to information which is stored in the DA by another domain manager.

24. The method of claim 22, wherein another domain manager corresponds to a system managing the user domain before the domain manager is registered to the DA.

25. The method of claim 22, wherein the requesting comprises:
requesting the DA to register the domain manager to the DA;
wherein the requesting of a DA to assign a domain manager to a user domain comprises requesting the DA to assign the domain manager to the user domain when the domain manager is registered to the DA.

26. The method of claim 24, wherein the requesting comprises:
receiving a DA credential from the DA; and
authenticating the DA by using the DA credential,
wherein the requesting comprises requesting the DA to assign the domain manager to the user domain when the DA is authenticated.

27. The method of claim 22, wherein the receiving comprises:
determining whether the domain manager is assigned to the user domain;
wherein the UDMS information is received when the domain manager is assigned to the user domain.

28. The method of claim 22, wherein the managing comprises:
receiving a user domain management request from a device which is positioned within a limited distance from the domain manager; and
managing the user domain in response to the user domain management request.

29. The method of claim 28, wherein the user domain management request comprises a device nonce, a domain manager identifier, a user domain identifier, and a device identifier.

30. The method of claim 28, wherein the user domain management request comprises at least one of a join request and a leave request with respect to the user domain of the device.

31. The method of claim 30, wherein the managing comprises:
allowing the device to join or leave the user domain in response to the join request or the leave request which is comprised in the user domain management request.

32. The method of claim 28, wherein the managing comprises:
authenticating the device;
creating a domain manager status request based on the user domain management request and transmitting the created domain manager status request to the DA;
receiving a domain manager status response from the DA;
updating the UDMS information based on the domain manager status response; and
creating a user domain management response based on the domain manager status response, and transmitting the created user domain management response to the device.

33. The method of claim 32, wherein the updating comprises:
transmitting the updated UDMS information to the DA.

34. A domain management method, comprising:
assigning a first domain manager to a user domain of a user;
storing user domain management state (UDMS) information about the user domain in a domain authority (DA);
assigning a second domain manager to the user domain;
receiving the UDMS information from the DA by the second domain manager; and
managing the user domain by the second domain manager, based on the UDMS information.

35. The method of claim 34, wherein the storing comprises:
receiving a DA credential from the DA; and
authenticating the DA by using the DA credential;
wherein the UDMS information is stored in the DA when the DA is authenticated.

36. The method of claim 34, wherein the managing comprises:
allowing a communicable device via a limited distance communication channel interface to join or leave the user domain as a member of the user domain;
updating the UDMS information according to the join or leave request; and
transmitting the updated UDMS information to the DA.

37. A computer-readable recording medium storing a program for implementing the method of claim 22.
